(19) United States
(12) Patent Application Publication
(10) Pub. No.: US 2018/0127980 A1
(43) Pub. Date: May 10, 2018

(54) REINFORCING BAR, METHOD FOR THE PRODUCTION, AND USE

(71) Applicant: Evonik Degussa GmbH, Essen (DE)

(72) Inventors: Dirk Fuchsmann, Haltern am See (DE); Vladislav Yaroslavskiy, Moscow (RU); Michael Vogel, Recklinghausen (DE); Eike Langkabel, Wegberg (DE); Martina Ortelt, Flein (DE); Wladimir Richter, Recklinghausen (DE)

(21) Appl. No.: 15/567,857

(22) PCT Filed: Apr. 8, 2016
(86) PCT No.: PCT/EP2016/057714

§ 371 Date: Oct. 19, 2017

(30) Foreign Application Priority Data
May 4, 2015 (EP) 15166241.8

(51) Int. Cl. E04C 5/07; E04C 5/01; C08J 5/04

(52) U.S. Cl. CPC E04C 5/07; C08J 5/044; C08J 5/043; E04C 5/015

(57) ABSTRACT

The invention relates to a rebar, to a method of production and to use of a composition. In particular, the invention relates to a rebar including A) at least one fibrous carrier, and B)and a hardened composition formed from B1) at least one epoxy compound, and B2) at least one diamine and/or polyaminein a stoichiometric ratio of the epoxy compound B1) to the diamine and/or polyamine component B2) of 0.8:1 to 2:1, as matrix material, and also C) optionally further auxiliaries and additives.

The invention relates to a rebar, to a method of production and to use of a composition.

Reinforcing bars or rebars are used especially in concrete construction. The standard rebars consist of steel.

### PRIOR ART

Alternative rebars which have been used for a while are those made from polymers, especially from fiber-reinforced polymers.

DE 101 21 021 A1 and DE 10 2007 027 015 A1 [Schöck] describe rebars made from fiber-reinforced polymer (GFR rebars) having milled ribs of different geometries at the surface of the bars for anchoring in the concrete. DE 101 21 021 mentions unsaturated polyester resins and vinyl ester resins as examples of the polymer matrix; no further details thereof are given. EP 0 427 111 B1 [Sportex] describes a method of producing fiber-reinforced polymer rebars having a sanded surface. In the method of the invention, an epoxy resin is used with preference. However, no details of the hardener system for the epoxy resin are given. WO 2010/139045 A1 [Brandstrom] mentions a method of providing continuous rebar material made from fiber-reinforced polymers. The GFR rebar material exhibits a distinctly lower modulus of elasticity than rebar steel and can therefore be wound onto a suitable device for provision at the construction site. Thermoset resin systems are used here, preferably vinyl ester resins. No further details are given as to the nature of the resin system. WO98/15403 [Marshall] has for its subject-matter a device for production of fiber-reinforced rebars. The method described envisages the use of a formable aluminium foil as a temporary aid for production of profiled and optionally curved GFR rebars. The polymer matrix consists of thermoset resin systems, preferably unsaturated polyester, vinyl ester or phenol resins. These resin systems can be used in combination with other thermosets, including epoxy resins, and also thermoplastic resins. Here too, no details whatsoever are given as to any preferred hardener system for the epoxy resin. The lifetime of built concrete structures is highly dependent on the type of reinforcement and on the quality of the bond between concrete and reinforcement. A conventional built structure of reinforced concrete (standard steel) has a lifetime of not significantly more than 30 years as a result of destruction of the reinforcement and the bond (oxidation, rust formation) by aggressive environmental influences (for example seawater exposure on coastlines and deicing salt exposure in the traffic infrastructure sector (for example bridges, roads, concrete crash barriers, noise protection walls, parking decks)). Higher-grade reinforcement is used here, for example duplex steel or stainless steel, where a lifetime of up to 70 years is expected. However, a disadvantage here is the much higher cost, which frequently makes such a solution unattractive. Rebars based on fiber-reinforced polymers are known; usually, unsaturated polyester resins and vinyl ester resins are used here as resin matrix. However, UP resins are not resistant to alkaline media, and vinyl ester resins do not attain the level of mechanical properties of epoxy resins. Anhydride-hardened epoxy resin formulations are already being used for the production of composite rebars, but even such a formulation does not attain the required alkali resistance.

Problem

The problem was that of finding new rebars which feature exceptional chemical resistance, especially to the alkaline medium of the concrete and to environmental influences such as salt water.

There was thus a need for a rebar which has exceptional corrosion resistance and hence an extremely long life. At the same time, all the demands on the profile of mechanical properties have to be fulfilled.

The problem was solved by the rebars according to the invention.

The invention provides rebars formed essentially from

A) at least one fibrous carrier

and

B) and a hardened composition formed from

B1) at least one epoxy compound

and

B2) at least one diamine and/or polyamine
in a stoichiometric ratio of the epoxy compound B1) to the diamine and/or polyamine component B2) of 0.8:1 to 2:1,
as matrix material,

and also

C) optionally further auxiliaries and additives.

The stoichiometric ratio of the epoxy compounds B1) to the diamine and/or polyamine B2) is 0.8:1 to 2:1, preferably 0.95:1, more preferably 1:1. The stoichiometric ratio is calculated as follows: a stoichiometric reaction means that one oxirane group in the epoxy resin reacts with one active hydrogen atom in the amine. A stoichiometric ratio of epoxy component B1) to amine component B2) of, for example, 0.8:1 means (epoxy equivalent [g/eq]×0.8) to (H-active equivalent of amine [g/eq]×1).

After the application and hardening of the composition B), preferably by thermal treatment, the rebars are non-tacky and can therefore be handled and processed further very efficiently. The compositions B) used in accordance with the invention have very good adhesion and distribution on the fibrous carrier.

The compositions B) used in accordance with the invention are liquid and hence suitable without addition of solvents for the impregnation of fiber material, environmentally friendly and inexpensive, have good mechanical properties, can be processed in a simple manner and feature good weathering resistance after hardening.

According to the invention, the rebars have exceptional chemical resistance, especially to the alkaline medium of concrete and salt water.

Fibrous Carrier A)

The fibrous carrier in the present invention consists of fibrous material, also often called reinforcing fibers. Any material that the fibers consist of is generally suitable, but preference is given to using fibrous material made of glass, carbon, plastics such as polyamide (aramid) or polyester, natural fibers, or mineral fiber materials such as basalt fibers or ceramic fibers (oxidic fibers based on aluminium oxides and/or silicon oxides). It is also possible to use mixtures of fiber types, for example combinations of aramid and glass fibers, or carbon and glass fibers.

Mainly because of their relatively low cost, glass fibers are the most commonly used fiber types.

In principle, all types of glass-based reinforcing fibers are suitable here (E glass, S glass, R glass, M glass, C glass, ECR glass, D glass, AR glass, or hollow glass fibers). Carbon fibers are generally used in high-performance composites, where another important factor is the lower density compared to glass fibers with simultaneously high strength. Carbon fibers are industrially produced fibers composed of carbonaceous starting materials which are converted by pyrolysis to carbon in a graphite-like arrangement. A distinction is made between isotropic and anisotropic types: isotropic fibers have only low strengths and lower industrial significance; anisotropic fibers exhibit high strengths and rigidities with simultaneously low elongation at break. Natural fibers refer here to all textile fibers and fibrous materials which are obtained from plant and animal material (for example wood fibers, cellulose fibers, cotton fibers, hemp fibers, jute fibers, flax fibers, sisal fibers and bamboo fibers). Similarly to carbon fibers, aramid fibers exhibit a negative coefficient of thermal expansion, i.e. become shorter on heating. Their specific strength and their modulus of elasticity are markedly lower than those of carbon fibers. In combination with the positive coefficient of expansion of the matrix resin, it is possible to produce components of high dimensional stability. Compared to carbon fiber-reinforced plastics, the compressive strength of aramid fiber composites is much lower. Known brand names for aramid fibers are Nomex® and Kevlar® from DuPont, or Teijinconex®, Twaron® and Technora® from Teijin. Particularly suitable and preferred carriers are those made of glass fibers, carbon fibers, aramid fibers or ceramic fibers. In the context of the invention, all the materials mentioned are suitable as fibrous carriers. An overview of reinforcing fibers is contained in “Composites Technologies”, Paolo Ermanni (Version 4), script for lecture at ETH Zürich, August 2007, Chapter 7.

The carrier material used with preference in accordance with the invention is characterized in that the fibrous carriers consist of glass, carbon, plastics (preferably of polyamide (aramid) or polyester), mineral fiber materials such as basalt fibers or ceramic fibers, individually or as mixtures of different fiber types.

Particular preference is given to glass fibers of any geometry, especially round glass fibers, either in the form of solid or hollow rods.

Particular preference is given to solid rods having surface profiling for firm anchoring in the concrete, for example by means of winding threads or the milling of an annular or spiral groove.

The rods may additionally be provided with a surface topcoat.

Matrix Material B)

Epoxy Compounds B1)

Suitable epoxy compounds B1) are described, for example, in EP 675 185.

Useful compounds are a multitude of those known for this purpose that contain more than one epoxy group, preferably two epoxy groups, per molecule. These epoxy compounds may either be saturated or unsaturated and be aliphatic, cycloaliphatic, aromatic or heterocyclic, and also have hydroxyl groups. They may additionally contain such substituents that do not cause any troublesome side reactions under the mixing or reaction conditions, for example alkyl or aryl substituents, ether moieties and the like. They are preferably glycidyl ethers which derive from polyhydric phenols, especially bisphenols and novolacs, and which have molar masses based on the number of epoxy groups ME (“epoxy equivalent weights”, “EV value”) between 100 and 1500, but especially between 150 and 250, g/eq.

Examples of polyhydric phenols include: resorcinol, hydroquinone, 2,2-bis(4-hydroxyphenyl)propane (bisphenol A), isomer mixtures of dihydroxydiphenylmethane (bisphenol F), 4,4′-dihydroxydiphenylcyclohexane, 4,4′-dihydroxy-3,3′-dimethyldiphenylpropane, 4,4′-dihydroxydiphenyl, 4,4′-dihydroxybenzophenone, bis(4-hydroxyphenyl)-1,1-ethane, bis(4-hydroxyphenyl)-1,1-isobutane, 2,2-bis(4-hydroxy-tert-butylphenyl)propane, bis(2-hydroxynaphthyl)methane, 1,5-dihydroxynaphthalene, tris(4-hydroxyphenyl)methane, bis(4-hydroxyphenyl) ether, bis(4-hydroxyphenyl) sulphone inter alia, and the chlorination and bromination products of the aforementioned compounds, for example tetrabromobisphenol A. Very particular preference is given to using liquid diglycidyl ethers based on bisphenol A and bisphenol F having an epoxy equivalent weight of 150 to 200 g/eq.

It is also possible to use polyglycidyl ethers of polyalcohols, for example ethane-1,2-diol diglycidyl ether, propane-1,2-diol diglycidyl ether, propane-1,3-diol diglycidyl ether, butanediol diglycidyl ether, pentanediol diglycidyl ether (including neopentyl glycol diglycidyl ether), hexanediol diglycidyl ether, diethylene glycol diglycidyl ether, dipropylene glycol diglycidyl ether, higher polyoxyalkylene glycol diglycidyl ethers, for example higher polyoxyethylene glycol diglycidyl ethers and polyoxypropylene glycol diglycidyl ethers, co-polyoxyethylene-propylene glycol diglycidyl ethers, polyoxytetramethylene glycol diglycidyl ether, polyglycidyl ethers of glycerol, of hexane-1,2,6-triol, of trimethylolpropane, of trimethylolethane, of pentaerythritol or of sorbitol, polyglycidyl ethers of oxyalkylated polyols (for example of glycerol, trimethylolpropane, pentaerythritol, inter alia), diglycidyl ethers of cyclohexanedimethanol, of bis(4-hydroxycyclohexyl)methane and of 2,2-bis(4-hydroxycyclohexyl)propane, polyglycidyl ethers of castor oil, triglycidyl tris(2-hydroxyethyl)isocyanurate.

Further useful components B1) include: poly(N-glycidyl) compounds obtainable by dehydrohalogenation of the reaction products of epichlorohydrin and amines such as aniline, n-butylamine, bis(4-aminophenyl)methane, m-xylylenediamine or bis(4-methylaminophenol)methane. The poly(N-glycidyl) compounds also include triglycidyl isocyanurate, triglycidylurazole and oligomers thereof, N,N′-diglycidyl derivatives of cycloalkyleneureas and diglycidyl derivatives of hydantoins inter alia.

In addition, it is also possible to use polyglycidyl esters of polycarboxylic acids which are obtained by the reaction of epichlorohydrin or similar epoxy compounds with an aliphatic, cycloaliphatic or aromatic polycarboxylic acid such as oxalic acid, succinic acid, adipic acid, glutaric acid, phthalic acid, terephthalic acid, tetrahydrophthalic acid, hexahydrophthalic acid, naphthalene-2,6-dicarboxylic acid and higher diglycidyl dicarboxylates, for example dimerized or trimerized linolenic acid. Examples are diglycidyl adipate, diglycidyl phthalate and diglycidyl hexahydrophthalate.

Mention should additionally be made of glycidyl esters of unsaturated carboxylic acids and epoxidized esters of unsaturated alcohols or unsaturated carboxylic acids. In addition to the polyglycidyl ethers, it is possible to use small amounts of monoepoxides, for example methyl glycidyl ether, butyl glycidyl ether, allyl glycidyl ether, ethylhexyl glycidyl ether, long-chain aliphatic glycidyl ethers, for example cetyl glycidyl ether and stearyl glycidyl ether, monoglycidyl ethers of a higher isomeric alcohol mixture, glycidyl ethers of a mixture of C12 to C13 alcohols, phenyl glycidyl ether, cresyl glycidyl ether, p-tert-butylphenyl glycidyl ether, p-octylphenyl glycidyl ether, p-phenylphenyl glycidyl ether, glycidyl ethers of an alkoxylated lauryl alcohol, and also monoepoxides such as epoxidized monounsaturated hydrocarbons (butylene oxide, cyclohexene oxide, styrene oxide), in proportions by mass of up to 30%, preferably 10% to 20%, based on the mass of the polyglycidyl ethers.

A detailed enumeration of the suitable epoxy compounds can be found in the handbook “Epoxidverbindungen and Epoxidharze” [Epoxy Compounds and Epoxy Resins] by A. M. Paquin, Springer Verlag, Berlin 1958, Chapter IV, and in Lee Neville “Handbook of Epoxy Resins”, 1967, Chapter 2.

Useful epoxy compounds B1) preferably include glycidyl ethers and glycidyl esters, aliphatic epoxides, diglycidyl ethers based on bisphenol A and/or bisphenol F, and glycidyl methacrylates. Other examples of such epoxides are triglycidyl isocyanurate (TGIC, trade name: ARALDIT 810, Huntsman), mixtures of diglycidyl terephthalate and triglycidyl trimellitate (trade name: ARALDIT PT 910 and 912, Huntsman), glycidyl esters of Versatic acid (trade name: CARDURA E10, Shell), 3,4-epoxycyclohexylmethyl 3′,4′-epoxycyclohexanecarboxylate (ECC), ethylhexyl glycidyl ether, butyl glycidyl ether, pentaerythrityl tetraglycidyl ether (trade name: POLYPDX R 16, UPPC AG), and other Polypox products having free epoxy groups.

It is also possible to use mixtures of the epoxy compounds mentioned.

The epoxy component B1) used more preferably comprises polyepoxides based on bisphenol A diglycidyl ether, bisphenol F diglycidyl ether or cycloaliphatic types. Preferably, epoxy resins used in the hardenable composition B) of the invention are selected from the group comprising epoxy resins based on bisphenol A diglycidyl ether, epoxy resins based on bisphenol F diglycidyl ether and cycloaliphatic types, for example 3,4-epoxycyclohexylepoxyethane or 3,4-epoxycyclohexylmethyl 3,4-epoxycyclohexanecarboxylate, particular preference being given to bisphenol A-based epoxy resins and bisphenol F-based epoxy resins.

According to the invention, it is also possible to use mixtures of epoxy compounds as component B1).

Amines B2)

Di-or polyamines B2) are known in the literature. These may be monomeric, oligomeric and/or polymeric compounds.

Monomeric and oligomeric compounds are preferably selected from the group of diamines, triamines, tetramines.

For component B2), preference is given to using primary and/or secondary di- or polyamines, particular preference to using primary di- or polyamines. The amino group of the di- or polyamines B2) may be attached to a primary, secondary or tertiary carbon atom, preferably to a primary or secondary carbon atom.

Components B2) used are preferably the following amines, alone or in mixtures:
aliphatic amines, such as the polyalkylenepolyamines, preferably selected from ethylene-1,2-diamine, propylene-1,2-diamine, propylene-1,3-diamine, butylene-1,2-diamine, butylene-1,3-diamine, butylene-1,4-diamine, 2-(ethylamino)ethylamine, 3-(methylamino)propylamine, diethylenetriamine, triethylenetetramine, pentaethylenehexamine, trimethylhexamethylenediamine, 2,2,4-trimethylhexamethylenediamine, 2,4,4-trimethylhexamethylenediamine, 2-methylpentanediamine, hexamethylenediamine, N-(2-aminoethyl)ethane-1,2-diamine, N-(3-aminopropyl)propane-1,3-diamine, N,N″-1,2-ethanediylbis(1,3-propanediamine), dipropylenetriamine, adipic dihydrazide, hydrazine;
oxyalkylenepolyamines selected from polyoxypropylenediamine and polyoxypropylenetriamine (e.g. Jeffamine® D-230, Jeffamine® D-400, Jeffamine® T-403, Jeffamine® T-5000), 1,13-diamino-4,7,10-trioxatridecane, 4,7-dioxadecane-1,10-diamine;
cycloaliphatic amines selected from isophoronediamine (3,5,5-trimethyl-3-aminomethylcyclohexylamine), 4,4′-diaminodicyclohexylmethane, 2,4′-diaminodicyclohexylmethane and 2,2′-diaminodicyclohexylmethane, alone or in mixtures of the isomers, 3,3′-dimethyl-4,4′-diaminodicyclohexylmethane, N-cyclohexyl-1,3-propanediamine, 1,2-diaminocyclohexane, 3-(cyclohexylamino)propylamine, piperazine, N-aminoethylpiperazine, TCD diamine (3(4),8(9)-bis(aminomethyl)tricyclo[5.2.1.0^{2,6}]decane),
araliphatic amines such as xylylenediamines;
aromatic amines selected from phenylenediamines, phenylene-1,3-diamine, phenylene-1,4-diamine, 4,4′-diaminodiphenylmethane, 2,4′-diaminodiphenylmethane, 2,2′-diaminodiphenylmethane, alone or in mixtures of the isomers;
adduct hardeners which are the reaction products of epoxy compounds, especially glycidyl ethers of bisphenol A and F, with excess amine;
polyamidoamine hardeners which are obtained by condensation of mono-and polycarboxylic acids with polyamines, especially by condensation of dimer fatty acids with polyalkylenepolyamines;
Mannich base hardeners which are obtained by reaction of mono- or polyhydric phenols with aldehydes, especially formaldehyde, and polyamines;
Mannich bases, for example based on phenol and/or resorcinol, formaldehyde and m-xylylenediamine, and also N-aminoethylpiperazine and blends of N-aminoethylpiperazine with nonylphenol and/or benzyl alcohol, phenalkamines which are obtained in a Mannich reaction from cardanols, aldehydes and amines.

It is also possible to use mixtures of the aforementioned di- or polyamines as component B2).

Preference is given to using diamines as component B2), selected from isophoronediamine (3,5,5-trimethyl-3-aminomethylcyclohexylamine, IPD), 4,4′-diaminodicyclohexylmethane, 2,4′-diaminodicyclohexylmethane, 2,2′-diaminodicyclohexylmethane (also referred to as PACM), alone or in mixtures of the isomers, a mixture of the isomers of 2,2,4-trimethylhexamethylenediamine and 2,4,4-trimethylhexamethylenediamine (TMD), adduct hardeners based on the reaction products of the epoxy compounds and the aforementioned amines or combinations of aforementioned amines. It is also possible to use mixtures of these compounds.

Very particular preference is given to using isophoronediamine (3,5,5-trimethyl-3-(aminomethyl)cyclohexylamine, IPD) and/or a combination of isophoronediamine and a mixture of the isomers of 2,2,4-trimethylhexamethylenediamine and 2,4,4-trimethylhexamethylenediamine (TMD) and/or adduct hardeners based on the reaction product of epoxy compounds and the aforementioned amines or combinations of the aforementioned amines.

In addition to the di- and polyamines B2), it is possible to use the di- and polyamines together with latent hardeners as component B2). The additional latent hardener used may in principle be any compound known for this purpose, i.e. any compound which is inert toward the epoxy resin below the defined limiting temperature of 80 DEG C. but reacts rapidly with crosslinking of the resin as soon as this melting temperature has been exceeded. The limiting temperature for the latent hardeners used is preferably at least 85 DEG C., especially at least 100 DEG C. Compounds of this kind are well known and also commercially available.

Examples of suitable latent hardeners are dicyandiamide, cyanoguanidines, for example the compounds described in U.S. Pat. No. 4,859,761 or EP-A-306 451, aromatic amines, for example 4,4- or 3,3-diaminodiphenyl sulphone, or guanidines, for example 1-o-tolylbiguanide, or modified polyamines, for example Ancamine™ 2014 S (Anchor Chemical UK Limited, Manchester).

Suitable latent hardeners are also N-acylimidazoles, for example 1-(2,4,6-trimethylbenzoyl)-2-phenylimidazole or 1-benzoyl-2-isopropylimidazole. Such compounds are described, for example, in U.S. Pat. No. 4,436,892, U.S. Pat. No. 4,587,311 or JP Patent 743,212.

Further suitable hardeners are metal salt complexes of imidazoles, as described, for example, in U.S. Pat. No. 3,678,007 or U.S. Pat. No. 3,677,978, carboxylic hydrazides, for example adipic dihydrazide, isophthalic dihydrazide or anthranilic hydrazide, triazine derivatives, for example 2-phenyl-4,6-diamino-s-triazine (benzoguanamine) or 2-lauryl-4,6-diamino-s-triazine (lauroguanamine), and melamine and derivatives thereof. The latter compounds are described, for example, in U.S. Pat. No. 3,030,247.

Also described as suitable latent hardeners are cyanoacetyl compounds, for example in U.S. Pat. No. 4,283,520, for example neopentyl glycol bis(cyanoacetate), N-isobutylcyanoacetamide, hexamethylene 1,6-bis(cyanoacetate) or cyclohexane-1,4-dimethanol bis(cyanoacetate).

Suitable latent hardeners are also N-cyanoacylamide compounds, for example N,N-dicyanoadipamide. Such compounds are described, for example, in U.S. Pat. No. 4,529,821, U.S. Pat. No. 4,550,203 and U.S. Pat. No. 4,618,712.

Further suitable latent hardeners are the acylthiopropylphenols described in U.S. Pat. No. 4,694,096 and the urea derivatives disclosed in U.S. Pat. No. 3,386,955, for example toluene-2,4-bis(N,N-dimethylcarbamide).

Preferred latent hardeners are 4,4-diaminodiphenyl sulphone and especially dicyandiamide. The abovementioned latent hardeners may be present in amounts of up to 30% by weight, based on the overall amine composition (component B2).

Auxiliaries and Additives C)

In addition to components A) and B) (carrier material and resin composition), the rebars may also include further additives; these are typically added to the resin composition B). For example, it is possible to add light stabilizers, for example sterically hindered amines, or other auxiliaries as described, for example, in EP 669 353 in a total amount of 0.05% to 5% by weight. Fillers and pigments, for example titanium dioxide or organic dyes, may be added in an amount of up to 30% by weight of the overall composition. For the production of the reactive compositions of the invention, it is additionally possible to add additives such as levelling agents, for example polysilicones, for adhesion promoters, for example those based on acrylate. In addition, still further components may optionally be present. Auxiliaries and additives used in addition may be chain transfer agents, plasticizers, stabilizers and/or inhibitors. In addition, it is possible to add dyes, fillers, wetting, dispersing and levelling aids, adhesion promoters, UV stabilizers, defoamers and rheology additives.

In addition, catalysts for the epoxy-amine reaction may be added. Suitable accelerators are described in: H. Lee and K. Neville, Handbook of Epoxy Resins, McGraw-Hill, N.Y., 1967. Normally, accelerators are used in amounts of not more than 10% and preferably in amounts of 5% or less, based on the total weight of the formulation.

Examples of suitable accelerators are organic acids such as salicylic acid, dihydroxybenzoic acid, trihydroxybenzoic acid, methyl salicylic acid, 2-hydroxy-3-isopropylbenzoic acid or hydroxynaphthoic acids, lactic acid and glycolic acid, tertiary amines such as benzyldimethylamine (BDMA), 1,4-diazabicyclo[2.2.2]octane (DABCO), triethylamine, N,N′-dimethylpiperazine or aminoethylpiperazine (AEP), hydroxylamines such as dimethylaminomethylphenol, bis(dimethylaminomethyl)phenol, 2,4,6-tris(dimethylaminomethyl)phenol (Ancamine K54), urons such as 3-(4-chlorophenyl)-1,1-dimethylurea (monuron), 3-(3,4-dichlorophenyl)-1,1-dimethylurea (diuron), 3-phenyl-1,1-dimethylurea (fenuron), 3-(3-chloro-4-methylphenyl)-1,1-dimethylurea (chlortoluron), tetraalkylguanidines such as N,N,N′,N′-tetramethylguanidine (TMG), imidazole and imidazole derivatives such as 1H-imidazole, 1-methylimidazole, 2-methylimidazole, 1-benzyl-2-methylimidazole, 2-ethyl-4-methylimidazole, 2-phenylimidazole, 2-phenyl-4-methylimidazole, 1-vinylimidazole, 1-(2-hydroxyethyl)imidazole, 1,2-dimethylimidazole, 1-cyanoethylimidazole and the suitable salts thereof, phenol and phenol derivatives such as t-butylphenol, nonylphenol, bisphenol A or bisphenol F, and organic or inorganic salts and complexes such as methyltriphenylphosphonium bromide, calcium nitrate (Accelerator 3130), or carboxylates, sulphonates, phosphonates, sulphates, tetrafluoroborates or nitrates of Mg, Ca, Zn and Sn.

The invention also provides a method of producing rebars formed essentially from

A) at least one fibrous carrier

and

B) and a hardened composition formed from

B1) at least one epoxy compound

and

B2) at least one diamine and/or polyamine
in a stoichiometric ratio of the epoxy compound B1) to the diamine and/or polyamine component B2) of 0.8:1 to 2:1,
as matrix material,

and also

C) optionally further auxiliaries and additives,

by applying a mixture of B1) and B2) and optionally C) to the fibrous carrier,

and then hardening the composition.

Application, Hardening, Temperatures, Methods, Variants

The inventive rebars composed of fiber-reinforced polymers are preferably produced by a pultrusion method. Pultrusion is a continuous production method for fiber-reinforced thermosets. The products are conventionally continuous profiles of uniform cross section. This involves conducting reinforcing materials, such as typically rovings, or else cut mats, continuous mats, scrims and nonwovens, alone or in combination, through a resin bath, stripping off excess resin, preforming the structure by means of appropriate slots and then pulling the impregnated fibers through a heated mould with an appropriate profile cross section or alternatively in a free-floating manner through a hardening apparatus, and hardening them. In summary, a pultrusion system consists of the following components:
an unwinding station for the reinforcing fibers
the impregnation device
the preforming and feeding unit
the mould (A) or the hardening device (B)
the pulling station
the finishing

The unwinding station consists of a creel for rovings and/or appropriate unwinding stations for two-dimensional reinforcing materials. The impregnation device may be an open resin bath or a closed multicomponent impregnating unit. The impregnation device may be heatable and/or designed with a circulation unit. After the fibers have been impregnated with the resin system, the impregnated reinforcing materials are conducted through apertures, in the course of which excess resin is stripped off and hence the target fiber volume content is established. The shape of the slots also continuously generates the preform of near net shape. The impregnated fiber preform thus defined then enters the heated mould. The pulling through the mould (A) causes the pultruded profile to receive its final dimensions and shape. During this shaping process, the component hardens. The heating is effected electrically or by means of thermal oil. Preferably, the mould is equipped with a plurality of independently controllable heating segments. Tools for pultrusion are usually between 75 cm and 1.50 m in length and may be one-piece or two-piece. The pulling station continuously pulls the reinforcing materials from the respective unwinding station, the reinforcing fibers through the impregnation unit, the impregnated fiber materials through the aperture and the continuously produced preform through the shaping mould, where the resin system then hardens and from which the finished profile exits at the end. The last element in the process chain is a processing station for surface configuration (e.g. mill), followed by a sawing station, where the pultruded profiles are then cut to the desired measurement.

Alternatively and preferably, the surface configuration of the rebars may follow the impregnation step and the stripping-off of excess resin and precede the entry of the fiber/matrix structure into a hardening apparatus (B). In this case, the impregnated combined fiber strand after the resin stripping is provided with winding threads wound around in a crosswise or spiral manner. The hardening apparatus in this case is an oven in which the continuously produced resin-impregnated fiber structure is hardened in a free-floating manner. The heating of the hardening apparatus or the introduction of heat into the material can be accomplished by means of hot air, IR radiation or microwave heating. Such a hardening apparatus typically has a length of 2 to 10 m, with independently controllable heating segments. The hardening is effected at temperatures between 100 and 300° C.; typical advance rates are 0.5 to 5 m/min.

At the end of the overall shaping process (hardening of the bars with surface configuration), a surface coating step may optionally also be effected.

The invention also provides for the use of a composition composed of

B1) at least one epoxy compound

and

B2) at least one diamine and/or polyamine
in a stoichiometric ratio of the epoxy compound B1) to the diamine and/or polyamine component B2) of 0.8:1 to 2:1,
as matrix material,

and also

C) optionally further auxiliaries and additives,

on at least one fibrous carrier A),

for production of rebars.

The bars of the invention are preferably used in concrete construction, for example in building construction and civil engineering with concrete. Because of their electromagnetic transparency, their corrosion resistance, their low modulus of elasticity (important in the case of dynamic stresses, for example in the event of earthquakes) and their relatively low weight, the current or future fields of use for composite reinforcements are preferably foundations, especially for transformers, reinforcement of buildings, tunnel construction projects, coastal and harbor defences, road and bridge building, and facade configurations. In conjunction with reinforcements composed of high-modulus fibers, for example carbon fibers, it is possible to use fiber-reinforced polymer rebars as reinforcement in prestressed concrete.

The invention also provides composites containing rebars formed essentially from

A) at least one fibrous carrier

and

B) and a hardened composition formed from

B1) at least one epoxy compound

and

B2) at least one diamine and/or polyamine
in a stoichiometric ratio of the epoxy compound B1) to the diamine and/or polyamine component B2) of 0.8:1 to 2:1,
as matrix material,

and also

C) optionally further auxiliaries and additives.

In the context of this invention, the term “composites” is used synonymously with the terms “composite components”, “composite material”, “composite moulding”, “fiber-reinforced plastic”.

### EXAMPLES

In order to determine the influence of alkaline media on the stability of the matrix system, exposure tests were conducted in an alkaline environment.

For storage in 10% sodium hydroxide solution at 80° C., pure resin slabs (4 mm) were cast; for hardening conditions see Table 1. The pure resin slabs obtained were used to produce test specimens of dimensions 50×50×4 mm and these were stored in 10% sodium hydroxide solution at 80° C. for 4 weeks. During this period, the change in weight was determined by weighing and the percentage change in weight was recorded, as shown in Table 1.

It is apparent that the sample based on the anhydride-based hardener system (Experiment 2, methyltetrahydrophthalic anhydride (MTHPA)), after initially increasing in weight, loses weight again. The samples were therefore redried after the storage had ended (1 month at RT). Under these conditions, a loss of mass of around one per cent was found in the case of the anhydride-hardened epoxy resin formulation (Experiment 2), whereas an increase in weight as a result of incorporated medium can still be detected in the case of the IPD-hardened epoxy resin formulation. All the results are compared in Table 1. This shows a substantial attack on the anhydride-hardened matrix by the alkaline medium, which is also reflected in the reduced glass transition temperature after chemical storage.

Examples and results are shown in Table 1:

TABLE 1

| | Experiment 1 | |
|---|---|---|
| | according | Experiment 2, |
| | to invention | comparative |
| | Amount used | Amount used |
| | in grams | in grams |
| Epikote 828 HEXION | 441 | 100 |
| 1-Methylimidazole | — | 0.5 |
| VESTAMIN IPD Evonik Industries | 100 | — |
| AG (isophoronediamine) | — | 90 |
| MTHPA | | |
| Hardening | 30 min, | 4 h 80° C. + |
| | 120° C. | 4 h 120° C. |

Measurement results

| | | |
|---|---|---|
| Tg after hardening^{a)} and storage | 144° C. | 132° C. |
| under ambient conditions (2 months, | | |
| “0 sample”) | | |
| Tg max.^{b)} of the 0 sample | 156° C. | 133° C. |

Storage in 10% sodium hydroxide solution at 80° C. for 1 month:

| | | |
|---|---|---|
| Change in mass after | | |
| 1 d | +0.56% | +0.28% |
| 3 d | +0.96% | +0.44% |
| 7 d | +1.26% | +0.38%* |
| 14 d | +1.46% | +0.18% |
| 28 d | +1.60% | +0.23% |

Redrying under ambient conditions for 1 month:

| | | |
|---|---|---|
| Change in mass relative to original | +1.23% | −0.90%* |
| Tg after storage in 10% sodium | 146° C. | 123° C.*** |
| hydroxide solution and redrying^{a)} | | |
| Tg max.^{b)} | 159° C. | 129° C. |

*the reversal of the trend in the changing mass indicates that the anhydride-based matrix (experiment 2) is being degraded
**the negative change in mass demonstrates that the anhydride-based matrix dissolves
***a Tg loss of 9° C. provides additional confirmation of the degradation of the matrix system in Experiment 2
^{a)}DSC experiment on test specimens hardened and stored under the conditions specified (pure resins). A sample was taken from the pure resin specimens and the glass transition temperature was determined in the DSC (heating rate 10 K/min up to a maximum temperature of 250° C.).
^{b)}The term “Tg max” refers to the result (=maximum attainable Tg of the material) of a 2nd DSC experiment on the same sample under identical conditions to those in ^{a)}.
All Tg measured by means of DSC in accordance with DIN EN ISO 11357-1.

DSC Mmeasurements

The DSC measurements were conducted to DIN EN ISO 11357-1 of March 2010.

A heat flux differential calorimeter from the manufacturer Mettler-Toledo, model: DSC 821 with serial number: 5116131417, was used. The samples were run twice from −30° C. to 250° C. at 10 K/min. The cooling ramp between the two measurements is 20 K/min.

Detailed description of the test method:
1. Type (heat flux differential calorimeter or performance-compensated calorimeter), model and manufacturer of the DSC unit used;
2. Material, form and type and, if required, mass of the crucible used;
3. Type, purity and flow rate of the purge gas used;
4. Type of calibration method and details of the calibration substances used, including source, mass and further properties of significance for the calibration;
5. Details of sampling, sample preparation and conditioning
1: Heat flux differential calorimeter
   Manufacturer: Mettler-Toledo
   Model: DSC 821
   Serial no.: 5116131417
2: Crucible material: ultrapure aluminium
   Size: 40 μl, no pin,
   Mettler cat. no.: ME-26763
   Mass including lid: about 48 mg
3: Purge gas: nitrogen
   Purity: 5.0 (>99.999% by vol.)
   Flow rate: 40 ml/min
4: Calibration method: simple
   Material 1: indium
   Mettler calibration set ME-51119991
   Mass: about 6 mg per weighing
   Calibration of temperature (onset) and heat flow
   Material 2: demineralized water
   Taken from the in-house system
   Mass: about 1 mg per weighing
   Calibration of temperature (onset)
5: Sampling: from specimen supplied
   Sample weight: 8 to 10 mg
   Sample preparation: none
   Crucible lid: perforated

Measurement program: −30 to 250° C., 10 K/min, 2×

1. A rebar comprising
A) at least one fibrous carrier;
B) a hardened composition comprising
B1) at least one epoxy compound
and
B2) at least one diamine and/or polyamine
in a stoichiometric ratio of the epoxy compound B1) to the diamine and/or polyamine component B2) of 0.8:1 to 2:1, as matrix material,
and
C) optionally further auxiliaries and additives.

2. The rebar according to claim 1, wherein the fibrous material selected from the group consisting of glass, carbon, polymers, natural fibers, mineral fiber materials and ceramic fibers.

3. The rebar according to claim 1, wherein epoxy compounds B1) selected from saturated, unsaturated, aliphatic, cycloaliphatic, aromatic and heterocyclic epoxy compounds are present, and these may also have hydroxyl groups.

4. The rebar according to claim 1, wherein epoxy compounds B1) selected from glycidyl ethers, glycidyl esters, aliphatic epoxides, diglycidyl ethers based on bisphenol A and/or bisphenol F, glycidyl methacrylates are present.

5. The rebar according to claim 1, wherein epoxy compounds B1) selected from the group comprising epoxy resins based on bisphenol A diglycidyl ether, epoxy resins based on bisphenol F diglycidyl ether and cycloaliphatic types are present.

6. The rebar according to claim 1, wherein amines B2) selected from primary and/or secondary di- and/or polyamines are present.

7. The rebar according to claim 1, wherein the amines B2) used are selected from the group consisting:
aliphatic amines, such as the polyalkylenepolyamines, preferably selected from ethylene-1,2-diamine, propylene-1,2-diamine, propylene-1,3-diamine, butylene-1,2-diamine, butylene-1,3-diamine, butylene-1,4-diamine, 2-(ethylamino)ethylamine, 3-(methylamino)propylamine, diethylenetriamine,triethylenetetramine, pentaethylenehexamine, trimethylhexamethylenediamine, 2,2,4-trimethylhexamethylenediamine, 2,4,4-trimethylhexamethylenediamine, 2-methylpentanediamine, hexamethylenediamine, N-(2-aminoethyl)ethane-1,2-diamine, N-(3-aminopropyl)propane-1,3-diamine, N,N″-1,2-ethanediylbis(1,3-propanediamine), dipropylenetriamine, adipic dihydrazide, hydrazine;
oxyalkylenepolyamines selected from polyoxypropylenediamine and polyoxypropylenetriamine;
cycloaliphatic amines selected from isophoronediamine (3,5,5-trimethyl-3-aminomethylcyclohexylamine), 4,4′-diaminodicyclohexylmethane, 2,4′-diaminodicyclohexylmethane and 2,2′-diaminodicyclohexylmethane, alone or in mixtures of the isomers, 3,3′-dimethyl-4,4′-diaminodicyclohexylmethane, N-cyclohexyl-1,3-propanediamine, 1,2-diaminocyclohexane, 3-(cyclohexylamino)propylamine, piperazine, N-aminoethylpiperazine, TCD diamine (3(4),8(9)-bis(aminomethyl)tricyclo[5.2.1.0^{2,6}]decane),
araliphatic amines;
aromatic amines selected from phenylenediamines, phenylene-1,3-diamine, phenylene-1,4-diamine, 4,4′-diaminodiphenylmethane, 2,4′-diaminodiphenylmethane, 2,2′-diaminodiphenylmethane, alone or in mixtures of the isomers;
adduct hardeners which are the reaction products of epoxy compounds, especially glycidyl ethers of bisphenol A and F, with excess amine;
polyamidoamine hardeners which are obtained by condensation of mono- and polycarboxylic acids with polyamines, especially by condensation of dimer fatty acids with polyalkylenepolyamines;
Mannich base hardeners which are obtained by reaction of mono- or polyhydric phenols with aldehydes, especially formaldehyde, and polyamines;
Mannich bases, formaldehyde, m-xylylenediamine, N-aminoethylpiperazine, blends of N-aminoethylpiperazine with nonylphenol and/or benzyl alcohol, phenalkamines which are obtained in a Mannich reaction from cardanols, aldehydes and amines.

8. The rebar according to claim 1, wherein amines B2) are selected from the group consisting of isophoronediamine, 4,4′-diaminodicyclohexylmethane, 2,4′-diaminodicyclohexylmethane, 2,2′-diaminodicyclohexylmethane, alone or in mixtures of the isomers, a mixture of the isomers of 2,2,4-trimethylhexamethylenediamine and 2,4,4-trimethylhexamethylenediamine, adduct hardeners based on the reaction product of epoxy compounds and amines B2) or a combination of the aforementioned amines B2) are present.

9. The rebar according to claim 1, wherein amines B2) are selected from the group consisting of isophoronediamine and/or a combination of isophoronediamine and a mixture of the isomers of 2,2,4-trimethylhexamethylenediamine and 2,4,4-trimethylhexamethylenediamine are present.

10. The rebar according to claim 1, wherein mixtures of the di- and/or polyamines with latent hardeners are used as component B2).

11. The rebar according to claim 1, wherein latent hardeners selected from dicyandiamide, cyanoguanidines, aromatic amines, guanidines, modified polyamines, N-acylimidazoles, imidazoles, carbonyl hydrazides, triazine derivatives, melamine and derivatives thereof, N-cyanoacylamide compounds, acylthiopropylphenolsare used.

12. A method of producing rebars
A) at least one fibrous carrier
and
B) a hardened composition formed from
B1) at least one epoxy compound
and
B2) at least one diamine and/or polyamine
in a stoichiometric ratio of the epoxy compound B1) to the diamine and/or polyamine component B2) of 0.8:1 to 2:1,
as matrix material,
and also
C) optionally further auxiliaries and additives,
by applying a mixture of B1) and B2) and optionally C) to the fibrous carrier,
and then hardening the composition.

13. The method according to claim 12, wherein the rebars are produced in a pultrusion method.

14-15. (canceled)

16. A composite comprising a rebar of claim 1.

17. Composites according to claim 16, wherein the fibrous material selected from the group consisting of glass, carbon, polymers, natural fibers, mineral fiber materials and ceramic fibers.

18. A composite comprising a rebar of claim 3.

19. A composite comprising a rebar of claim 4.

20. A composite comprising a rebar of claim 5.

21. A composite comprising a rebar of claim 6.

22. A composite comprising a rebar of claim 7.
